(19) United States
(12) Patent Application Publication
(10) Pub. No.: US 2025/0371459 A1
(43) Pub. Date: Dec. 4, 2025

(54) OPERATION PLAN DERIVATION SYSTEM AND OPERATION PLAN DERIVATION METHOD

(71) Applicants: SAMSUNG DISPLAY CO., LTD., YONGIN-SI (KR); Pusan National University Industry- University Cooperation Foundation, Busan (KR)

(72) Inventors: KYUNIL JANG, Yongin-si (KR); SOONDO HONG, Busan (KR); JUNHEUI LEE, Yongin-si (KR); JIMIN HAN, Yongin-si (KR); BONGGWON KANG, Busan (KR); GWANGHEON LEE, Busan (KR)

(21) Appl. No.: 19/062,725

(22) Filed: Feb. 25, 2025

(30) Foreign Application Priority Data
Jun. 4, 2024 (KR) 10-2024-0072998

(51) Int. Cl. G06Q 10/0631

(52) U.S. Cl. CPC G06Q 10/06312

(57) ABSTRACT

An operation plan derivation method includes outputting a plurality of initial operation plans by sampling a plurality of operation plans using a first algorithm. Each of the plurality of initial operation plans has an operation factor and a judgment factor corresponding to the operation factor. A simulation is performed on the plurality of initial operation plans. An optimal operation plan is output. The performing of the simulation includes evaluating a potential of an unobserved operation plan among the plurality of operation plans using a second algorithm. A plurality of areas is defined that includes the plurality of initial operation plans based on the evaluated potential. A weight is assigned according to the evaluated potential to each of the plurality of areas using a third algorithm. The plurality of operation plans is additionally sampled depending on the assigned weight using the first algorithm.

### CROSS-REFERENCE TO RELATED APPLICATIONS

This application claims priority under 35 U.S.C. § 119 to Korean Patent Application No. 10-2024-0072998, filed on Jun. 4, 2024 in the Korean Intellectual Property Office, the disclosure of which is incorporated by reference in its entirety herein.

### 1. TECHNICAL FIELD

Embodiments of the present disclosure described herein relate to an operation plan derivation system and an operation plan deriving method with increased reliability.

### 2. DISCUSSION OF RELATED ART

In general, factories have introduced many automated production processes (e.g., lines). Automated factories are being transformed into smart factories by introducing Internet of Things (IoT) devices into each process step, which may increase productivity, determine the aging of parts, and increase work efficiency.

A user experience-based simulation may be performed to derive an optimal operation plan for a factory. In this case, the possibility that decision-making bias occurs due to a user's recent experience may increase. There is also a possibility that a simulation according to a change in decision-making effectiveness is inefficiently performed, and there is no quantified optimal operation plan.

### SUMMARY

Embodiments of the present disclosure provide an operation plan derivation system and an operation plan derivation method with increased reliability.

According to an embodiment of the present disclosure, an operation plan derivation method includes outputting a plurality of initial operation plans by sampling a plurality of operation plans using a first algorithm. Each of the plurality of initial operation plans has an operation factor and a judgment factor corresponding to the operation factor. A simulation is performed on the plurality of initial operation plans. An optimal operation plan is output. The performing of the simulation includes evaluating a potential of an unobserved operation plan among the plurality of operation plans using a second algorithm. A plurality of areas is defined that includes the plurality of initial operation plans based on the evaluated potential. A weight is assigned according to the evaluated potential to each of the plurality of areas using a third algorithm. The plurality of operation plans is additionally sampled depending on the assigned weight using the first algorithm.

In an embodiment, the outputting of the optimal operation plan may include repeatedly performing the simulation on the additionally sampled operation plans when the simulation is performed less than a predetermined number of times.

In an embodiment, the outputting of the optimal operation plan may include outputting the optimal operation plan when the simulation is performed the predetermined number of times.

In an embodiment, the first algorithm, the second algorithm, and the third algorithm may be different from each other.

In an embodiment, the first algorithm may include a Latin hypercube sampling (LHS) algorithm.

In an embodiment, the second algorithm may include a decision tree.

In an embodiment, the third algorithm may include a roulette wheel selection algorithm.

In an embodiment, the outputting of the plurality of initial operation plans may include outputting the judgment factor by performing a distributed simulation on the operation factor of each of the plurality of initial operation plans by a plurality of computing nodes.

In an embodiment, the additionally sampling of the plurality of operation plans may include outputting the judgment factor by performing a distributed simulation on the operation factor of each of additionally sampled operation plans by a plurality of computing nodes.

In an embodiment, the additionally sampling of the plurality of operation plans may include further sampling an area having the assigned weight that is relatively high from among the plurality of areas.

According to an embodiment of the present disclosure, an operation plan derivation system includes a server outputting an optimal operation plan by performing a simulation on a plurality of operation plans. Each of the plurality of operation plans has an operation factor and a judgment factor corresponding to the operation factor. A plurality of computing nodes in which each of the plurality of computing nodes receives the operation factor from the server and transmits the judgment factor to the server. The server includes an initial sampling unit that outputs a plurality of initial operation plans by sampling the plurality of operation plans using a first algorithm. A simulation unit performs a simulation on the plurality of initial operation plans. An optimal operation plan derivation unit outputs the optimal operation plan based on the judgment factor when a termination condition is satisfied in the simulation unit.

In an embodiment, the simulation unit may include a space classification unit that evaluates a potential of an unobserved operation plan among the plurality of operation plans using a second algorithm, a space selection unit that defines a plurality of areas including the plurality of initial operation plans based on the evaluated potential, a weight assignment unit that assigns a weight according to the evaluated potential to each of the plurality of areas using a third algorithm, and an additional sampling unit that additionally samples the plurality of operation plans depending on the assigned weight using the first algorithm.

In an embodiment, the termination condition may be defined as a number of times that the simulation is performed. When the simulation is performed less than a predetermined number of times, the optimal operation plan derivation unit may repeatedly perform the simulation on the additionally sampled operation plans.

In an embodiment, when the simulation is performed the predetermined number of times, the optimal operation plan derivation unit may output the optimal operation plan.

In an embodiment, the first algorithm, the second algorithm, and the third algorithm may be different from each other.

In an embodiment, the first algorithm may include a Latin hypercube sampling (LHS) algorithm.

In an embodiment, the second algorithm may include a decision tree.

In an embodiment, the third algorithm may include a roulette wheel selection algorithm.

In an embodiment, each of the plurality of computing nodes may output the judgment factor by performing a distributed simulation on the operation factor of each of the plurality of initial operation plans.

In an embodiment, each of the plurality of computing nodes may output the judgment factor by performing a distributed simulation on the operation factor of each of the additionally sampled operation plans.

### BRIEF DESCRIPTION OF THE DRAWINGS

The above and other objects and features of the present disclosure will become apparent by describing in detail non-limiting embodiments thereof with reference to the accompanying drawings.

FIG. 1 shows an operation plan derivation system, according to an embodiment of the present disclosure.

FIG. 2 is a block diagram showing a simulation unit, according to an embodiment of the present disclosure.

FIG. 3 is a flowchart showing a method for deriving an operation plan, according to an embodiment of the present disclosure.

FIG. 4 shows a Latin hypercube, according to an embodiment of the present disclosure.

FIG. 5 shows a decision tree, according to an embodiment of the present disclosure.

FIG. 6 shows upper q % areas, according to an embodiment of the present disclosure.

FIG. 7 illustrates a roulette wheel for applying a weight, according to an embodiment of the present disclosure.

FIG. 8 shows a Latin hypercube, according to an embodiment of the present disclosure.

FIG. 9 is a box graph obtained by comparing a comparative example and an embodiment of the present disclosure.

### DETAILED DESCRIPTION OF EMBODIMENTS

In the specification, the expression that a first component (or region, layer, part, portion, etc.) is “on”, “connected with”, or “coupled with” a second component means that the first component is directly on, connected with, or coupled with the second component or means that a third component is interposed therebetween. When a first component is described as being “directly on”, “directly connected with”, or “directly coupled with” a second component, this means that no intervening component are interposed therebetween.

The same reference numerals refer to the same components. Also, in drawings, the thickness, ratio, and dimension of components may be exaggerated for effectiveness of description of technical contents. The term “and/or” includes one or more combinations in each of which associated elements are defined.

Although the terms “first”, “second”, etc. may be used to describe various components, the components should not be construed as being limited by the terms. The terms are only used to distinguish one component from another component. For example, without departing from the scope and spirit of embodiments of the present disclosure, a first component may be referred to as a second component, and similarly, the second component may be referred to as the first component. The articles “a,” “an,” and “the” are singular in that they have a single referent, but the use of the singular form in the specification should not preclude the presence of more than one referent.

Also, the terms “under”, “below”, “on”, “above”, etc. are used to describe the correlation of components illustrated in drawings. These terms are relative in concept and are described based on a direction shown in drawings.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Terms “part” and “unit” mean a software component or hardware component that performs a specific function. For example, the hardware component may include a field-programmable gate array (FPGA) or an application-specific integrated circuit (ASIC). The software component may refer to executable codes and/or data used by the executable codes in an addressable storage medium. Accordingly, the software components may be, for example, object-oriented software components, class components, and task components, and may include processes, functions, attributes, procedures, subroutines, program code segments, drivers, firmware, microcodes, circuits, data, databases, data structures, tables, arrays, or variables.

Unless otherwise defined, all terms (including technical terms and scientific terms) used in the specification have the same meaning as commonly understood by one skilled in the art to which embodiments of the present disclosure belong. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the present disclosure will be described with reference to accompanying drawings.

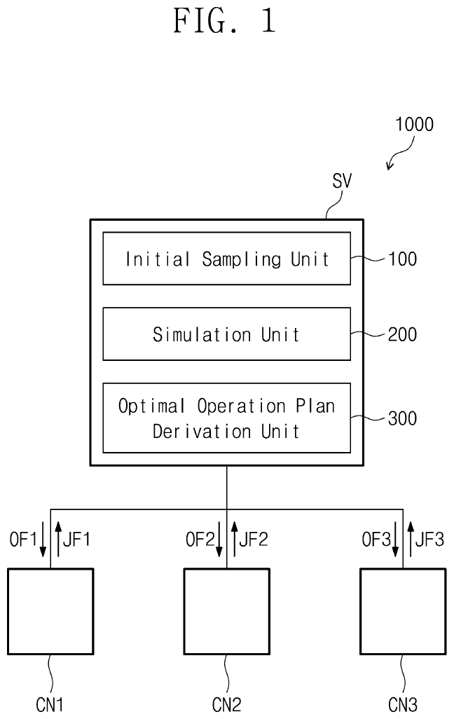

FIG. 1 shows an operation plan derivation system, according to an embodiment of the present disclosure.

Referring to FIG. 1, in an embodiment an operation plan derivation system 1000 may include a server SV and a plurality of computing nodes CN1, CN2, and CN3. While an embodiment of FIG. 1 shows the plurality of computing nodes include three computing nodes CN1, CN2 and CN3 embodiments of the present disclosure are not necessarily limited thereto and the number of the computing nodes may vary.

The server SV may simulate a plurality of operation plans and may output an optimal operation plan.

Each of the plurality of operation plans may have operation factors OF1, OF2, and OF3 and judgment factors JF1, JF2, and JF3 corresponding thereto. While an embodiment of FIG. 1 shows the operation factors including three operation factors OF1, OF2, and OF3 and the judgment factors including three judgment factors JF1, JF2, and JF3, embodiments of the present disclosure are not necessarily limited thereto.

In an embodiment, the operation factors OF1, OF2, and OF3 may be conditions set by field workers. For example, in an embodiment the operation factors OF1, OF2, and OF3 may include the number of transfer facilities, movement paths of the transfer facilities, and the like. However, embodiments of the present disclosure are not necessarily limited thereto.

The judgment factors JF1, JF2, and JF3 may be result values obtained by performing a simulation based on the operation factors OF1, OF2, and OF3. For example, in an embodiment each of the judgment factors JF1, JF2, and JF3 may include return time.

In an embodiment, the server SV may include an initial sampling unit 100, a simulation unit 200, and an optimal operation plan derivation unit 300.

The initial sampling unit 100 may output a plurality of initial operation plans by sampling a plurality of operation plans by using a first algorithm. In an embodiment, the first algorithm may include a Latin hypercube sampling (LHS) algorithm.

The simulation unit 200 may simulate the plurality of initial operation plans. The simulation unit 200 may transmit the operation factors OF1, OF2, and OF3 respectively corresponding to the sampled operation plans to the plurality of computing nodes CN1, CN2, and CN3.

According to an embodiment of the present disclosure, the simulation unit 200 may perform a distributed simulation through the plurality of computing nodes CN1, CN2, and CN3. The execution time of an operation plan derivation method may be reduced. Accordingly, the operation plan derivation system 1000 with increased reliability may be provided.

When a termination condition is satisfied in the simulation unit 200, the optimal operation plan derivation unit 300 may output the optimal operation plan based on the judgment factors JF1, JF2, and JF3.

In an embodiment, the plurality of computing nodes CN1, CN2, and CN3 may include the first computing node CN1, the second computing node CN2, and the third computing node CN3.

FIG. 1 illustrates three computing nodes, but the number of computing nodes according to an embodiment of the present disclosure is not necessarily limited thereto. For example, in some embodiments the number of computing nodes may be provided depending on the number of computing nodes performing the distributed simulation.

The first computing node CN1 may receive the first operation factor OF1 from the server SV. The first computing node CN1 may output the first judgment factor JF1 by performing a simulation based on the first operation factor OF1. The first computing node CN1 may transmit the first judgment factor JF1 to the server SV.

The second computing node CN2 may receive the second operation factor OF2 from the server SV. The second computing node CN2 may output the second judgment factor JF2 by performing a simulation based on the second operation factor OF2. The second computing node CN2 may transmit the second judgment factor JF2 to the server SV.

The third computing node CN3 may receive the third operation factor OF3 from the server SV. The third computing node CN3 may output the third judgment factor JF3 by performing a simulation based on the third operation factor OF3. The third computing node CN3 may transmit the third judgment factor JF3 to the server SV.

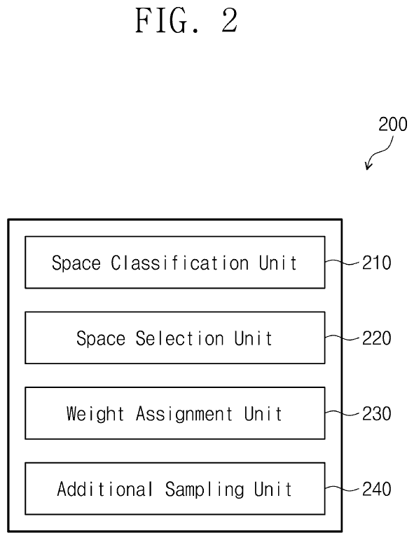

FIG. 2 is a block diagram showing a simulation unit, according to an embodiment of the present disclosure.

Referring to FIG. 2, in an embodiment the simulation unit 200 may include a space classification unit 210, a space selection unit 220, a weight assignment unit 230, and an additional sampling unit 240.

In an embodiment, the space classification unit 210 may evaluate the potential of an unobserved operation plan (e.g., an operation plan that has not yet been simulated) among a plurality of operation plans by using a second algorithm. In an embodiment, the second algorithm may include a decision tree.

According to an embodiment of the present disclosure, the space classification unit 210 may quantitatively estimate the potential for the unobserved operation plan through the second algorithm. Accordingly, the operation plan derivation system 1000 with increased reliability may be provided.

In an embodiment, the space selection unit 220 may define a plurality of areas, which respectively include a plurality of initial operation plans, based on the potential evaluated by the space classification unit 210.

In an embodiment, the weight assignment unit 230 may assign a weight according to the evaluated potential to each of the plurality of areas by using a third algorithm. In an embodiment, the third algorithm may include a roulette wheel selection algorithm. For example, in an embodiment each of the first to third algorithms may be different from each other.

In an embodiment, the additional sampling unit 240 may additionally sample the plurality of operation plans depending on a weight by using the first algorithm.

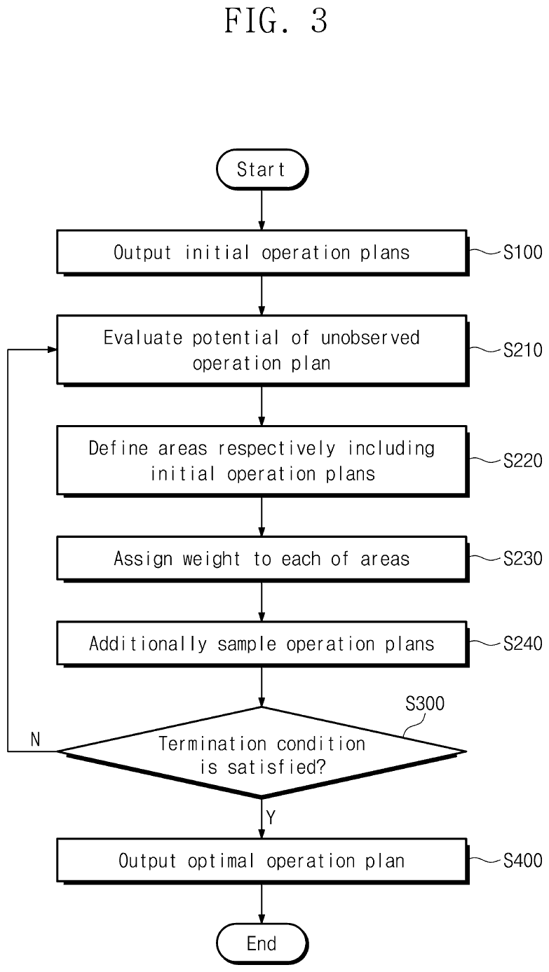

FIG. 3 is a flowchart showing a method for deriving an operation plan, according to an embodiment of the present disclosure.

Referring to FIGS. 1 to 3, in an embodiment, an operation plan derivation method may include operation S100 of outputting a plurality of initial operation plans by sampling a plurality of operation plans using a first algorithm. Each of the plurality of operation plans has an operation factor and a judgment factor according to the operation factor. A simulation is performed on the plurality of initial operation plans in operations S210 to S240. An operation S300 of determining whether a termination condition is satisfied is performed. An operation S400 of outputting an optimal operation plan.

In an embodiment, the operation of performing the simulation may include operation S210 of evaluating potential of an unobserved operation plan among the plurality of operation plans by using a second algorithm, operation S220 of defining a plurality of areas including the plurality of initial operation plans based on the evaluated potential, operation S230 of assigning a weight according to the evaluated potential to each of the plurality of areas by using a third algorithm, and operation S240 of additionally sampling the plurality of operation plans depending on the weight by using the first algorithm.

After the plurality of operation plans are additionally sampled, it may be determined whether the termination condition is satisfied in operation S300. In some embodiments, the termination condition may be defined as the number of times that the simulation is performed and whether the number of times that the simulation is performed is equal to a predetermined number of times. For example, in an embodiment the number of times that the simulation is performed may be arbitrarily defined by a user.

TABLE 1

Input: I, P
Output: x^{opt}
Obtain initial design points by P in [symbol] ,
x⁽⁰⁾ = LHS( [symbol] , P)
For p := 1 to P do
${y}_{p}^{( 0 )} = f ( {x}_{p}^{( 0 )} )$
End
D = {x⁽⁰⁾, y⁽⁰⁾}
For i := 1 to I do
Obtain s from DecisionTree(D) where s = {s₁, ... , sₖ}
Select best q percentage leaf nodes as \tilde{s}
b = RouletteWheelSelection(\tilde{s})
x⁽ⁱ⁾ = {LHS(\tilde{s}₁, b₁)∪ ... ∪LHS(\tilde{s}ₖ, bₖ)}
For p := 1 to P do
${y}_{p}^{( i )} = f ( {x}_{p}^{( i )} )$
End
Update D with {x⁽ⁱ⁾, y⁽ⁱ⁾}
End
${i}^{*} , {p}^{*} = arg {min}_{∀ i ∈ I , p ∈ P} {y}_{p}^{( i )}$
$Return {x}^{opt} = {x}_{{p}^{*}}^{( {i}^{*} )}$

Table 1 shows a pseudo-code of the operation plan derivation method using the operation plan derivation system 1000, according to an embodiment of the present disclosure. Referring to Table 1, the operation plan derivation system 1000 may receive I value and P value from outside. I value may be referred to as a “termination condition”. I value may be the number times that the simulation is performed by the simulation unit 200. P value may be the sampling number of the first algorithm.

In an embodiment, each of I value and P value may be arbitrarily defined by the user.

For example, when I value is set to be relatively small, the operation plan derivation system 1000 may quickly output the optimal operation plan with a relatively small number of iterations, but may output the optimal operation plan of low reliability. When I value is set to be relatively large, the operation plan derivation system 1000 may output an optimal operation plan with high reliability, but the time required to output the optimal operation plan may increase.

For example, when P value is set to be relatively small, the operation plan derivation system 1000 may quickly output the optimal operation plan by using a small sampling, but may output the optimal operation plan of low reliability. When P value is set to be relatively large, the operation plan derivation system 1000 may output an optimal operation plan with high reliability, but the time required to output the optimal operation plan may increase.

The operation plan derivation system 1000 may output an optimal operation plan with an optimal operation factor x^{opt} by using the operation plan derivation method.

In an embodiment, the initial sampling unit 100 may generate the plurality of initial operation plans by sampling the plurality of operation plans, each of which has an operation factor and a judgment factor according to the operation factor, by the number corresponding to P value by using the first algorithm in operation S100. For example, the number of initial operation plans may be ‘P’.

Each of the plurality of initial operation plans may have an operation factor x⁽⁰⁾.

In an embodiment, the first algorithm may include a Latin Hypercube Sampling (LHS) algorithm. However, this is an example, and the type of the first algorithm according to an embodiment of the present disclosure is not necessarily limited thereto. For example, in an embodiment the first algorithm may further include a Monte Carlo sampling algorithm.

In an embodiment, the plurality of computing nodes CN1, CN2, and CN3 may receive an operation factor x⁽⁰⁾ of each of the plurality of initial operation plans from the server SV. In an embodiment, each of the plurality of computing nodes CN1, CN2, and CN3 may perform a distributed simulation and may output a judgment factor

$${y}_{p}^{( 0 )} .$$

The operation may be referred to as an operation of evaluating an operation plan.

The initial sampling unit 100 may provide the simulation unit 200 with data ‘D’, which defines an operation factor

$${x}_{p}^{( 0 )}$$

and a judgment factor

$${y}_{p}^{( 0 )}$$

In an embodiment, the simulation unit 200 may perform the following simulation operations as many as I value, which is the termination condition.

The space classification unit 210 may evaluate potential s₁, . . . , sₖ of an unobserved operation plan among a plurality of operation plans by using a second algorithm in operation S210. For example, in an embodiment the potential may be judgment factors classified by a decision tree.

In an embodiment, the second algorithm may include a decision tree. For example, the decision tree may be a widely used algorithm in prediction modeling and may be a data mining technique.

The space selection unit 220 may define a plurality of areas including the plurality of initial operation plans based on the evaluated potential s₁, . . . , sₖ in operation S220. The plurality of areas may be referred to as “upper q % areas”.

In an embodiment, the space selection unit 220 may select the upper q % area according to the potential s₁, . . . , sₖ of the classified area. The upper q % area may refer to an operation plan area having each potential s₁, . . . , sₖ among the entire operation plan area. A set [symbol] of each of upper q % areas may be provided to the weight assignment unit 230.

In an embodiment, the weight assignment unit 230 may assign a weight b₁, . . . , bₖ according to the potential s₁, . . . , sₖ to each of the plurality of areas by using a third algorithm in operation S230. In an embodiment, the third algorithm may include a roulette wheel selection algorithm.

In an embodiment, the weight assignment unit 230 may select the sampling number for each space through the third algorithm after assigning a prediction result proportion weight b for each of the selected plurality of areas. For example, an area with a relatively high weight may have a greater sampling number than an area with a relatively low weight.

In an embodiment, the additional sampling unit 240 may additionally sample the plurality of operation plans depending on the weight b₁, . . . , bₖ by using the first algorithm in operation S240. The additional sampling unit 240 may sample the plurality of operation plans as many as b value according to the weight assigned by the weight assignment unit 230 to each of the plurality of areas. The P value may be obtained by summing the operation plans sampled by the number of weights b₁, . . . , bₖ in each area.

For example, the number of additionally sampled operation plans may be the number obtained by adding P, which is the number of initial operation plans, and the number ‘P’ of operation plans thus additionally sampled.

In an embodiment, each of the additional sampled operation plans may have an operation factor x⁽ⁱ⁾.

In an embodiment, the plurality of computing nodes CN1, CN2, and CN3 may receive an operation factor

$${x}_{p}^{( i )}$$

of each of the additionally sampled operation plans from the server SV. Each of the plurality of computing nodes CN1, CN2, and CN3 may output a judgment factor

$${y}_{p}^{( i )}$$

by performing a distributed simulation.

In an embodiment, the additional sampling unit 240 may update the data ‘D’ based on the operation factor

$${x}_{p}^{( i )}$$

and the judgment factor

$${y}_{p}^{( i )} .$$

The simulation unit 200 may determine whether the termination condition is satisfied in block S300. The termination condition may be determined by I value.

When the termination condition is not satisfied, the simulation unit 200 may re-perform the simulation operation based on the updated data ‘D’.

When the termination condition is satisfied, the simulation unit 200 may provide the data ‘D’ to the optimal operation plan derivation unit 300.

In an embodiment, the optimal operation plan derivation unit 300 may obtain the operation factor

$${x}_{{p}^{*}}^{( {i}^{*} )}$$

to minimize the judgment factor

$${y}_{p}^{( i )} .$$

The operation factor

$${x}_{{p}^{*}}^{( {i}^{*} )}$$

at this time may be referred to as the optimal operation factor x^{opt}.

In an embodiment, the optimal operation plan derivation unit 300 may output an optimal operation plan with an optimal operation factor x^{opt} in operation S400.

According to an embodiment of the present disclosure, the operation plan derivation method may classify operation plans depending on the potential as many as the number ‘I’ of iterations thus entered and may generate and evaluate an operation plan by weighting a variable range for each operation factor of a selected operation plan area with a relatively high potential. Accordingly, the operation plan derivation method may derive an optimal operation plan. For example, an operation plan derivation method may generate an operation plan by focusing on an operation plan area having a relatively high potential, thereby deriving a highly efficient optimal operation plan with a relatively small number of times that a simulation is performed. Accordingly, the operation plan derivation method and the operation plan derivation system 1000 with increased reliability may be provided.

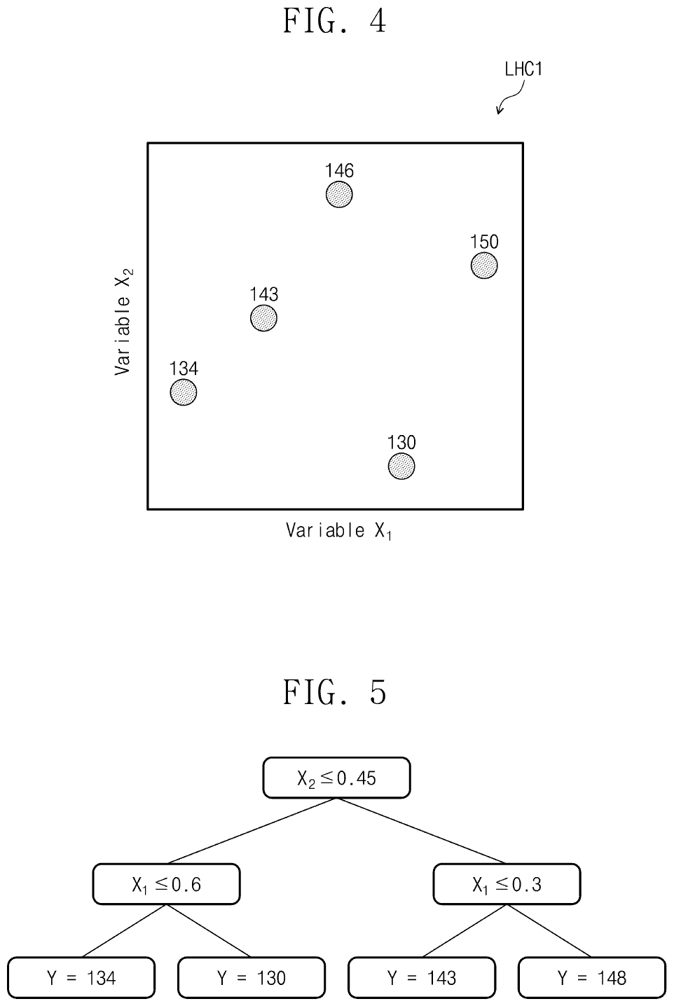

FIG. 4 shows a Latin hypercube, according to an embodiment of the present disclosure.

Referring to FIGS. 1 and 4, in an embodiment a Latin hypercube sampling method may select sample data in consideration of space filling for the space constituting a variable and a function for the variable, may perform a simulation with the selected sample data, may calculate the average and deviation for the result value, and may calculate reliability in this way.

The initial sampling unit 100 may generate an initial sample based on Latin hypercube sampling. In an embodiment, the initial sample may be a plurality of initial operation plans LHC1 with variable X₁ and variable X₂. Each of variable X₁ and variable X₂ may be an operation factor.

In an embodiment, the operation plan derivation system 1000 may evaluate initial samples through a distributed simulation through the plurality of computing nodes CN1, CN2, and CN3. The plurality of computing nodes CN1, CN2, and CN3 may output judgment factors of the plurality of initial operation plans LHC1, respectively. For example, in some embodiments the judgment factor may have values such as 130, 134, 143, 146, 150, and the like.

The initial sampling unit 100 may output the plurality of initial operation plans LHC1 by showing the judgment factor according to an operation factor. In FIG. 4, P value, which is the sampling number, may be set to 5. For this reason, the number of initial operation plans LHC1 may be 5.

FIG. 5 shows a decision tree, according to an embodiment of the present disclosure.

Referring to FIGS. 1, 2, and 5, the plurality of initial operation plans LHC1 (see FIG. 4) may be learned and classified by a decision tree model.

In an embodiment, the variable X₂ may be classified based on whether it is less than or equal to 0.45 or greater than 0.45.

In an embodiment, when the variable X₂ is less than or equal to 0.45, the variable X₁ may be classified based on whether it is less than or equal to 0.6 or greater than 0.6. In an embodiment, when the variable X₂ is greater than 0.45, the variable X₁ may be classified based on whether it is less than or equal to 0.3 or greater than 0.3. For example, in an embodiment when the variable X₂ is less than or equal to 0.3 the judgment factor of 134 may be assigned.

The classification criteria for variable X₁ and variable X₂ are examples, and the decision tree according to an embodiment of the present disclosure is not necessarily limited thereto.

Judgment factors ‘Y’ classified for this reason may be defined as the potential of an unobserved operation plan. For example, the potential classified by the space classification unit 210 may be 134, 130, 143, and 148. For example, in an embodiment, when the variable X₂ is less than or equal to 0.45 and the variable X₁ is less than or equal to 0.6, the judgment factor Y of 134 may be assigned. When the variable X₂ is less than or equal to 0.45 and the variable X₁ is greater than 0.6, the judgment factor Y of 130 may be assigned. In an embodiment, when the variable X₂ is greater than 0.45 and the variable X₁ is less than or equal to 0.3, the judgment factor Y of 143 may be assigned. When the variable X₂ is greater than 0.45 and the variable X₁ is greater than 0.3, the judgment factor Y of 148 may be assigned. However, embodiments of the present disclosure are not necessarily limited thereto.

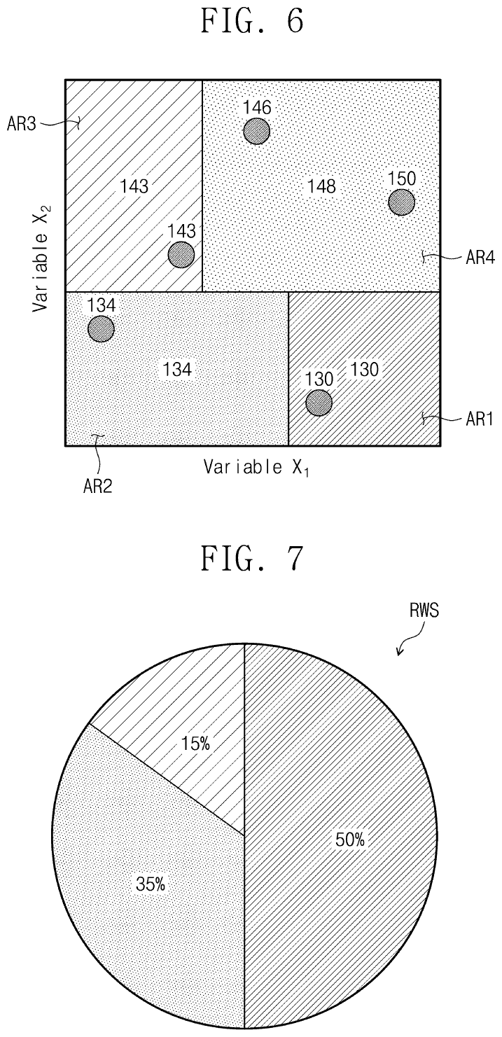

FIG. 6 shows upper q % areas, according to an embodiment of the present disclosure.

Referring to FIGS. 1, 2, 5, and 6, the space selection unit 220 may select the upper q % area according to the potential of the classified area. For example, in an embodiment the space selection unit 220 may divide the entire area into four areas according to the four pieces of potential classified by the space classification unit 210. In FIG. 6, hatching is different for each area to visually express potential.

Judgment factors of the plurality of initial operation plans LHC1 may be included in the upper q % areas. For example, as shown in an embodiment of FIG. 6 a first area AR1 with potential of 130 may include an initial operation plan with a judgment factor of 130; a second area AR2 with potential of 134 may include an initial operation plan with a judgment factor of 134; a third area AR3 with potential of 143 may include an initial operation plan with a judgment factor of 143; and a fourth area AR4 with potential of 148 may include initial operation plans with judgment factors of 146 and 150.

In this embodiment, the first area AR1 is an area where the judgment factor is likely to have a relatively low value, and the fourth area AR4 is an area where the judgment factor is likely to have a relatively high value.

FIG. 7 illustrates a roulette wheel for applying a weight, according to an embodiment of the present disclosure.

Referring to FIGS. 1, 2, 6, and 7, operation plans according to an embodiment of the present disclosure may be an optimal operation plan as a judgment factor has a relatively lower value.

The weight assignment unit 230 may assign a weight to the selected q % area. For example, in an embodiment the weight assignment unit 230 may assign a weight of 50% to the first area AR1, may assign a weight of 35% to the second area AR2, may assign a weight of 15% to the third area AR3, and may not assign a weight to the fourth area AR4.

In an embodiment, the weight assignment unit 230 may select the sampling number for each space through a roulette wheel algorithm RWS. Since the P value, which is the sampling number, is set to 5, the sampling number of 3 may be assigned to the first area AR1 depending on the weight. For example, since a value obtained by multiplying the sampling number by the weight is 2.5, the sampling number of 3 may be assigned by rounding off the value.

The sampling number of 2 may be assigned to the second area AR2. For example, since a value obtained by multiplying the sampling number by the weight is 1.75, the sampling number of 2 may be assigned by rounding off the value.

Since the sampling number has already been satisfied, the sampling number may not be assigned to the third area AR3 and the fourth area AR4.

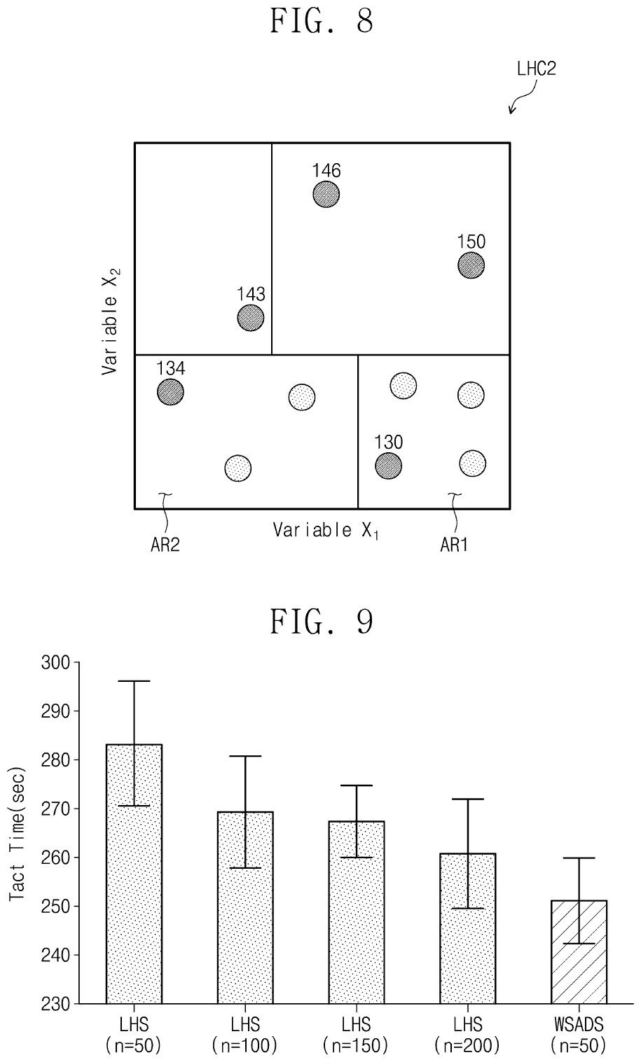

FIG. 8 shows a Latin hypercube, according to an embodiment of the present disclosure.

Referring to FIGS. 1, 2, and 8, in an embodiment the additional sampling unit 240 may additionally sample the plurality of operation plans depending on a weight by using the first algorithm.

In an embodiment, the additional sampling unit 240 may additionally sample three operation plans in the first area AR1 and may additionally sample two operation plans in the second area AR2.

In an embodiment the number of additionally sampled operation plans LHC2 may be the number obtained by adding ‘P’, which is the number of initial operation plans, and ‘P’ operation plans, which is obtained by additionally sampling the plurality of operation plans. For example, the number of additionally sampled operation plans output from the additional sampling unit 240 may be 10. For example, whenever a simulation is performed by the simulation unit 200, ‘P’ operation plans may be added.

The operation plan derivation system 1000 may evaluate initial samples through a distributed simulation through the plurality of computing nodes CN1, CN2, and CN3. The plurality of computing nodes CN1, CN2, and CN3 may output judgment factors of the plurality of operation plans LHC2 thus additionally sampled, respectively.

When a termination condition is not satisfied, the simulation unit 200 may re-classify the plurality of operation plans LHC2 thus additionally sampled, by using a decision tree model. For example, the simulation unit 200 may perform an operation of deriving the best sample through the utilizing of the first to third algorithms until the termination condition is satisfied.

FIG. 9 is a box graph obtained by comparing a comparative example and an embodiment of the present disclosure.

Referring to FIGS. 1, 2, and 9, comparative examples LHS refer to a method of deriving an optimal operation plan by uniformly sampling a plurality of operation plans.

In the comparative examples LHS 50, 100, 200, and 300 are illustrated depending on the simulation execution number ‘n’.

An embodiment WSADS outputs an optimal operation plan by using the operation plan derivation method according to an embodiment of the present disclosure. The embodiment WSADS may have the simulation execution number ‘n’ of 50. In the embodiment WSADS, P value may be 10 and I value may be 4. In this embodiment, the simulation execution number ‘n’ of 50 is defined by performing “10+ (10*4)” by the initial operation plan of 10 and the additional sampling operation repeated by the simulation unit 200.

Tact time may be a judgment factor of the optimal operation plan output by each of the comparative examples LHS and the embodiment WSADS. As the tact time is relatively small, it may be determined as the optimal operation plan.

TABLE 2

| | Simulation | Tact |
|---|---|---|
| | execution number | time(sec) |
| Comparative | 50 | 283.5 |
| example | 100 | 269.8 |
| (LHS) | 200 | 267.7 |
| | 300 | 261.2 |
| Embodiment WSADS | 50 | 251.5 |

Table 2 schematically shows a graph shown in FIG. 9 as a table. When the comparative example LHS having 50 simulation times is compared with the embodiment WSADS of the present disclosure, the average tact time may be reduced by about 11.29%. When the comparative example LHS having 300 simulation times is compared with the embodiment WSADS of the present disclosure, not only is the average the tact time reduced by approximately 3.71%, but the number of times that the simulation is performed may also be reduced by 83.3%. A decrease in the number of times that the simulation is performed may mean a decrease in the simulation execution time

TABLE 3

| | Simulation | |
|---|---|---|
| Whether there is | execution | Execution |
| distribution | number | time (sec) |
| Comparative example | 50 | 3193.72 |
| (distribution is not | | |
| applied) | | |
| Embodiment | 50 | 724.91 |
| (distribution is applied) | | |

Table 3 shows the execution time according to whether a distributed simulation is performed by using the plurality of computing nodes CN1, CN2, and CN3. In an embodiment, when the simulation is performed 50 times without performing the distributed simulation, the execution time may be 3193.72 seconds.

Although FIG. 1 illustrates the three computing nodes CN1, CN2, and CN3, the distributed simulation in Table 3 may be performed by five computing nodes.

In this embodiment, when the simulation is performed 50 times by using the distributed simulation, the execution time may be 724.91 seconds.

When the comparative example is compared with an embodiment of the present disclosure (e.g., WSADS), the execution time may be reduced by about 77.6% based on whether the distributed simulation of the plurality of computing nodes CN1, CN2, and CN3 is performed.

According to an embodiment of the present disclosure, an operation plan derivation method may generate an operation plan by focusing on an operation plan area having a relatively high potential, thereby deriving a highly efficient optimal operation plan with a relatively small number of times that a simulation is performed. Furthermore, an optimal operation plan may be derived in a short time by using distributed simulation. Accordingly, the operation plan derivation method and the operation plan derivation system 1000 with increased reliability may be provided.

Although an embodiment of the present disclosure has been described for illustrative purposes, those skilled in the art will appreciate that various modifications, and substitutions are possible, without departing from the scope and spirit of the present disclosure. Accordingly, the technical scope of embodiments of the present disclosure is not limited to the described embodiments.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An operation plan derivation method, the method comprising:
outputting a plurality of initial operation plans by sampling a plurality of operation plans using a first algorithm, each of the plurality of initial operation plans has an operation factor and a judgment factor corresponding to the operation factor;
performing a simulation on the plurality of initial operation plans; and
outputting an optimal operation plan,
wherein the performing of the simulation includes:
evaluating a potential of an unobserved operation plan among the plurality of operation plans using a second algorithm;
defining a plurality of areas including the plurality of initial operation plans based on the evaluated potential;
assigning a weight according to the evaluated potential to each of the plurality of areas using a third algorithm; and
additionally sampling the plurality of operation plans depending on the assigned weight using the first algorithm.

2. The method of claim 1, wherein the outputting the optimal operation plan includes:
when the simulation is performed less than a predetermined number of times, repeatedly performing the simulation on additionally sampled operation plans.

3. The method of claim 2, wherein the outputting the optimal operation plan includes outputting the optimal operation when the simulation is performed the predetermined number of times.

4. The method of claim 1, wherein the first algorithm, the second algorithm, and the third algorithm are different from each other.

5. The method of claim 1, wherein the first algorithm includes a Latin hypercube sampling (LHS) algorithm.

6. The method of claim 1, wherein the second algorithm includes a decision tree.

7. The method of claim 1, wherein the third algorithm includes a roulette wheel selection algorithm.

8. The method of claim 1, wherein the outputting the plurality of initial operation plans includes:
outputting the judgment factor by performing a distributed simulation on the operation factor of each of the plurality of initial operation plans by a plurality of computing nodes.

9. The method of claim 1, wherein the additionally sampling of the plurality of operation plans includes:
outputting the judgment factor by performing a distributed simulation on the operation factor of each of additionally sampled operation plans by a plurality of computing nodes.

10. The method of claim 1, wherein the additionally sampling of the plurality of operation plans includes:
further sampling an area, having the assigned weight that is relatively high from among the plurality of areas.

11. An operation plan derivation system, the system comprising:
a server outputting an optimal operation plan by performing a simulation on a plurality of operation plans, each of the plurality of operation plans has an operation factor and a judgment factor corresponding to the operation factor; and
a plurality of computing nodes, each of the plurality of computing nodes receives the operation factor from the server and transmits the judgment factor to the server,
wherein the server includes:
an initial sampling unit outputting a plurality of initial operation plans by sampling the plurality of operation plans using a first algorithm;
a simulation unit performing a simulation on the plurality of initial operation plans; and
an optimal operation plan derivation unit outputting the optimal operation plan based on the judgment factor when a termination condition is satisfied in the simulation unit.

12. The system of claim 11, wherein the simulation unit includes:
a space classification unit evaluating a potential of an unobserved operation plan among the plurality of operation plans using a second algorithm;
a space selection unit defining a plurality of areas including the plurality of initial operation plans based on the evaluated potential;
a weight assignment unit assigning a weight according to the evaluated potential to each of the plurality of areas using a third algorithm; and
an additional sampling unit additionally sampling the plurality of operation plans depending on the assigned weight using the first algorithm.

13. The system of claim 12, wherein the termination condition is defined as a number of times that the simulation is performed, and
wherein when the simulation is performed less than a predetermined number of times, the optimal operation plan derivation unit repeatedly performs the simulation on the additionally sampled operation plans.

14. The system of claim 13, wherein when the simulation is performed the predetermined number of times, the optimal operation plan derivation unit outputs the optimal operation plan.

15. The system of claim 12, wherein the first algorithm, the second algorithm, and the third algorithm are different from each other.

16. The system of claim 12, wherein the first algorithm includes a LHS algorithm.

17. The system of claim 12, wherein the second algorithm includes a decision tree.

18. The system of claim 12, wherein the third algorithm includes a roulette wheel selection algorithm.

19. The system of claim 12, wherein each of the plurality of computing nodes outputs the judgment factor by performing a distributed simulation on the operation factor of each of the plurality of initial operation plans.

20. The system of claim 12, wherein each of the plurality of computing nodes outputs the judgment factor by performing a distributed simulation on the operation factor of each of additionally sampled operation plans.
